(19) United States
(12) Patent Application Publication
(10) Pub. No.: US 2004/0264916 A1
(43) Pub. Date: Dec. 30, 2004

(54) Method of enabling interaction using a portable device

(76) Inventors: Bartel Marinus Van De Sluis, Einhoven (NL); Elmo Marcu Attila Diederiks, Eindhoven (NL); Koen Hendrik Johan Vrielink, Eindhoven (NL)

Correspondence Address: Philips Corporation, Intellectual Property Department, P O Box 3001, Briarcliff Manor, NY, 10510, US

(21) Appl. No.: 10/498,301

(22) PCT Filed: Dec. 5, 2002
(86) PCT No.: PCT/IB02/05256

(30) Foreign Application Priority Data
Dec. 14, 2001 (EP) 01204905.2

(51) Int. Cl. H04N 5/76

(52) U.S. Cl. 386/46; 386/125

(57) ABSTRACT

A method of enabling interaction between a portable device (201) operated by a user and another device (202) comprising detecting that a distance between the portable device (201) and the other device (202) is suitable for the interaction, suggesting to the user that a virtual link can be established between the portable device (201) and the other device (202) for allowing the interaction, and upon receiving confirmation from the user, establishing the virtual link.

The invention relates to a method of enabling interaction between a portable device operated by a user and another device, to such a portable device and to a computer program product.

Traditionally, when someone owns multiple devices such as televisions, video recorders, DVD player/recorders, radios and so on, he interconnects these devices using cables. Using the link established by the cable connection, the interconnected devices can interact with each other. For example, a television can activate a video recorder to start a recording of a television program.

Today, more and more devices become both wireless and portable. The most well known example is of course the remote control. Using infrared transmissions, the portable remote control device can send instructions to a receiver, such as a television, to control it. However, a typical remote control operates by simply transmitting the infrared signals in the hopes that a receiver will pick them up and act accordingly. There is no link between the remote control and the television like there is between for example the television and the video recorder.

Not only does the absence of a link make it more difficult for the portable device to reliably communicate with the other device (the receiver), it is also harder for a user of the portable device to determine which other device he is controlling with it. Having multiple remote controls available for controlling or interacting with other devices is often a source of confusion: which remote control should be used for which device?

Now that even television systems, video recorders, DVD players/recorders and so on can be interconnected in a wireless fashion, the above problem will only become more prevalent. Using a single “universal” remote control only partially solves this problem: while a universal remote control reduces the confusion as to which remote control should be used for which device, it does not address the issue of identifying which device is presently being controlled by the universal remote control.

More sophisticated portable devices, such as wireless headphones, handheld computers or displays, mobile (video) phones and so on can be used at any location for all kinds of activities in a “stand-alone” way. Due to portability considerations, the portable device is typically made as small or “thin” as possible, i.e. low power consumption, compact, lightweight, and so on. The small size of the portable device causes an associated display or speaker to be rather small. The small display or speaker make it difficult to adequately present information to a user. However, if these portable devices are used in the proximity of other devices, it might be advantageous to use some of the capabilities of these other devices. For example, a television program that is being watched on a small portable television screen could be better presented on a larger, stationary display screen, or a song being played over the headphone of a mobile phone could be rendered instead via the stereo system installed in the living room.

If these devices can communicate wirelessly with each other, then it becomes possible to transfer the “session” (i.e. the watching of a television program, listening to audio, and so on) from the portable device to the other device. One technique for doing so is described in international patent application WO 02/43359 (attorney docket PHTW000008) by the same applicant as the present application. It may also be desirable to transfer the session from the large, stationary device to the portable device, to e.g. allow a user to keep listening to a radio station on his portable device when leaving the living room where his home audio system is installed.

In such systems, there is a large number of devices that can communicate and interact with each other using wireless communication systems. Thus, a cable connection between these devices is no longer necessary. However, the physical connection such as a cable between devices clearly indicate which devices “work together”. So, since a cable is no longer necessary, this indication is now lost to the user.

It is an object of the invention to provide a method according to the preamble, that provides an interaction concept which allows a user to explicitly relate devices to each other.

This object is achieved according to the invention in a method comprising detecting that a distance between the portable device and the other device is suitable for the interaction, suggesting to the user that a virtual link can be established between the portable device and the other device for allowing the interaction, and upon receiving a confirmation from the user, establishing the virtual link.

By establishing the virtual link only after receiving confirmation from the user, it is achieved that the user is aware of the link between the portable device and the other device. The link can be used for allowing a variety of possible interactions between these devices.

It is known per se to establish communication sessions between devices, in particular between portable devices and other devices such as television systems. Such communication sessions can be used to exchange information between the two devices. The communication sessions can be aborted at any time, and often is not even a true “session” but only an exchange of messages.

In an embodiment the method comprises receiving the confirmation as a user action performed on the portable device. This is a very convenient way of receiving a confirmation from a user, and so is advantageous in that it complies with user expectations.

In a further embodiment the method comprises receiving the confirmation as an indication of a physical action performed with the portable device. It is easier to manipulate the portable device itself than it is to manipulate a small button or icon on a display.

In a further embodiment the physical action comprises bringing the portable device in the immediate proximity of the other device. Such a physical action intuitively suggests that some kind of interaction between the portable device and the other device is desired.

In a further embodiment the physical action comprises bringing the portable device in the immediate proximity of an object representative of a device cluster comprising the other device. It is of course not necessary that the portable device is brought in the immediate proximity of the other device itself. An object representative of the other device, or representative of a device cluster comprising the other device could also be used. This has the advantage that the object can be adapted to be easily recognized. The user is then encouraged to bring the portable device in the immediate proximity thereof.

In a further embodiment the method comprises deriving an action that is desired by the user from the manner in which the confirmation is given by the user, and subsequently executing the action using the virtual link. It is possible to establish the link by, amongst others:

tapping on a graphical element, referred to here as a linking bar, that appears at a border of the display of the portable device (a ‘taplink’),

dragging a content or activity icon on the linking bar (a ‘drag link’), or

moving the portable device close (preferably less than 15 cm) to the other device for a brief period of time (a ‘screen link’).

These different actions represent different metaphors used for interacting between the portable device and the other device. For example, tapping a graphical element on a display is typically used to acknowledge something, so detecting a taplink serves as an indication that the user wants to establish the virtual link and wants to use his portable device to participate in whatever is going on on the other device.

The act of “dragging” is known from the PC world, where it is used to manipulate files or objects represented by icons. An icon can be dragged to an application, and then the application will be started using the file represented by the icon as input. Dragging an icon representative of a television program or other content item to a linking bar (representative of the other device) can be used here as an indication that the user wants to transfer the rendering of the content item to the other device.

In a further embodiment the method comprises detecting a further user action indicative of desired termination, and in response to said detecting, terminating the virtual link. A user action such as quickly moving the portable device away from the other device or increasing the distance between portable device and other device so that it exceeds the distance suitable for interaction serves as an indication that the user is no longer interested in virtual link. The virtual link should then be terminated.

It is a further object of the invention to provide a portable device arranged to be operated by a user, comprising arranged to be operated by a user, comprising interacting means for interacting with another device, detecting means for detecting that a distance between the portable device and the other device is suitable for the interaction, output means for indicating that a virtual link can be established between the portable device and the other device for allowing the interaction, confirmation reception means for receiving a confirmation from the user, linking means for, upon receiving a confirmation from the user, activating the interacting means and establishing the virtual link.

In an embodiment the portable device further comprises means for detecting a physical action performed with the portable device, coupled to the confirmation reception means.

The invention further relates to a computer program product arranged for causing a processor to execute the method according to the invention.

These and other aspects of the invention will be apparent from and elucidated with reference to the embodiments shown in the drawing, in which:

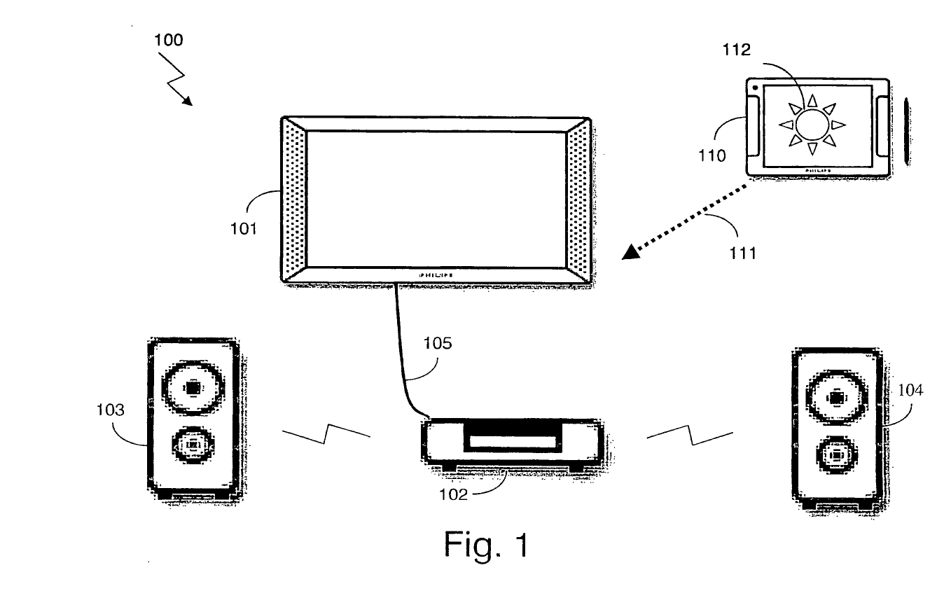

FIG. 1 schematically shows a system according to the invention;

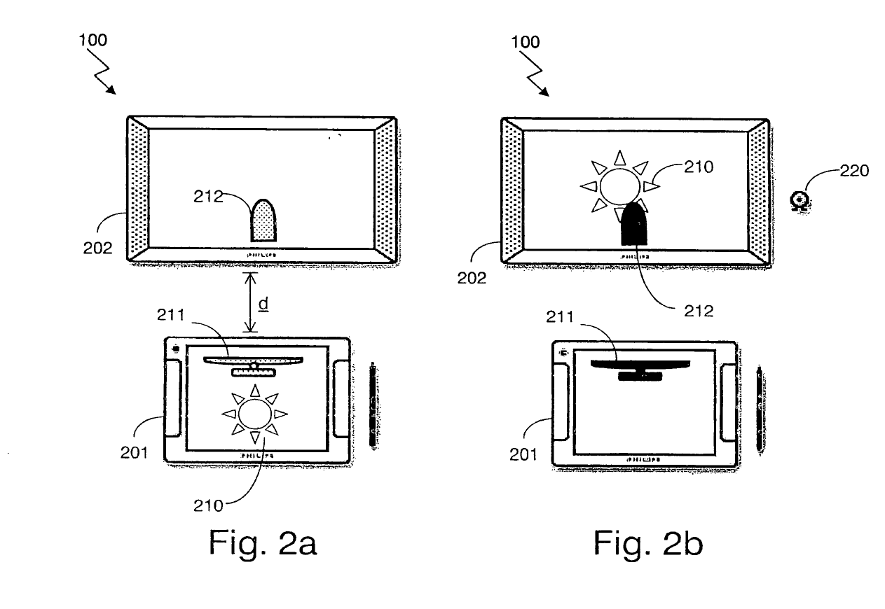

FIGS. 2a and b schematically illustrate operation of an embodiment of the system; and

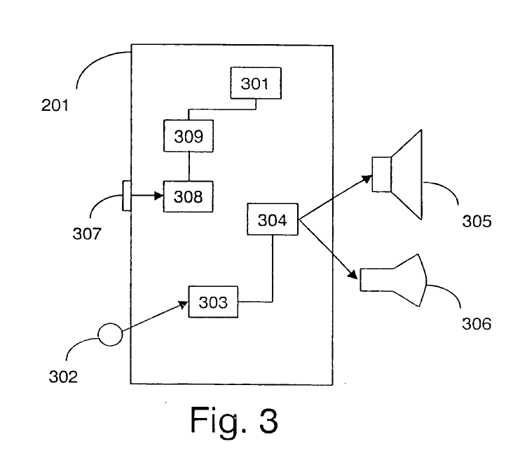

FIG. 3 schematically shows a portable device for use in such a system.

Throughout the figures, same reference numerals indicate similar or corresponding features. Some of the features indicated in the drawings are typically implemented in software, and as such represent software entities, such as software modules or objects.

FIG. 1 schematically shows a system 100 comprising a display screen 101, a DVD playback system 102 and loudspeakers 103 and 104. The display screen 101 and the DVD player 102 are interconnected using cable 105, whereas the loudspeakers 103 and 104 are connected to the DVD player 102 in a wireless fashion. For example, the audio accompanying a movie shown on the display screen 101 could be transmitted wirelessly to the loudspeakers 103 and 104 so the user can hear them. The devices 101-104 could equally well all be interconnected using cable connections or using only wireless connections.

The devices 101-104 can be regarded as a group or “cluster” of devices, much in the same way as a traditional group of devices interconnected using a cable connection. The application of the devices 101-104 in the cluster preferably dynamically adapts to the capabilities of the device cluster. At start-up the application will search for the devices in the cluster and query them for their user interface capabilities. This way the application can get an overview of the available capabilities and determine its best possible user interface. This optimal user interface may use the capabilities of several devices. So after the UT has been dynamically designed, the application must send the various parts to the various devices via the network between the devices.

For the devices in the device cluster this means that they must be able to expose their UI-capabilities to other device on the network. And they must be able to receive part of the UI of an application, which runs one another device. If devices are added, then this will be communicated to the application by the underlying networking system and the application may re-design its user interface and take advantage of the added functionality. Should for instance a second user with PDA walk into the environment where the Formula 1 application is running, then the Formula 1 application could decide to give also this user also control over the application and put the controls of the application also on the new PDA.

Such a cluster is often formed by devices that are all present in the same room. This means that, conceptually speaking, entering and leaving the room corresponds to joining or leaving the cluster.

In this embodiment a portable device 110 is brought in the vicinity of the system 100. This is indicated by dotted arrow 111. The portable device 110 could be for instance a portable television screen on which a content item 112 is being presented. Content in this context refers to items such as music, songs, movies, TV programs, pictures and so on. Since the device 110 is portable, it must be relatively small and lightweight. This means that the display on the portable device 110 is much smaller than the display on the display screen 101.

For other types of portable devices a similar relationship may exist. For example, the portable device 110 may comprise a portable audio system, whose loudspeakers or headphones are of lower quality than the loudspeakers 103 and 104. The portable device 110 could also be a handheld computer or a remote control device. It is assumed that the portable device 110 has some kind of wireless communication means, allowing it to establish a communication session with at least one of the devices 101-104. A suitable technology for communication between portable device 110 and display screen 101 is IEEE 802.11 or Bluetooth or the like.

As the portable device 110 is brought into the vicinity 111 of the system 100, at some point the distance between the portable device 110 and one of the devices in the system 100 will become suitable for establishing the virtual link. Preferably this distance is about three meters, although this depends on the specific arrangement of the devices 101-104 in the system 100. In any case, the distance should be adjusted based on an expected viewing/listening distance for a user of the device(s). For instance, for a large projection screen in the living room this distance would be larger than for a small television in the kitchen, which is presumably smaller than the living room.

At this point, the portable device 110 and the other device (in this case the display screen 101, for the sake of ex ample) detect that the distance corresponds to the previously chosen suitable distance using e.g. RF signals. The devices 101, 110 then establish a communication session to exchange information regarding to respective capabilities and so on. Using this communication session, the portable device 110 learns that the display screen 101 has a much better screen for rendering the content item 112.

Reference is made to international patent application WO 02/43359 (PHTW000008) which describes how such a communication session can be established and how it can be used by the portable device 110 to learn about the capabilities of the display screen 101. It is observed that the Bluetooth specification provides for exchange of information regarding capabilities of devices.

Having learned that the display screen 101 is more suited to rendering the content item 112, the portable device 110 now suggests to the user that a virtual link with the display screen 101 can be established. The term “virtual link” as used here does not mean merely a wireless connection between the portable device 110 and the display screen 101. The virtual link also focuses the operation of the portable device 110 on the display screen 101, e.g. by only permitting control commands to be sent to the display screen 101 and not to the DVD playback system 102.

The suggestion can be made in a variety of ways. The portable device 110 could display a message on its display, and/or generate a sound to alert the user. The portable device 110 and the display screen 101 might comprise a Light-Emitting Diode (LED) which could be activated unobtrusively to make the suggestion, for example by blinking.

After seeing, hearing or otherwise noticing the suggestion, the user can make an informed choice whether to establish the virtual link. The confirmation can be received as a user action performed on the portable device 110. This can be simply letting the user press a (virtual or physical) button on the portable device 110, or tapping a specific portion of the display.

The confirmation can also be received as an indication of a physical action performed with the portable device 110. For instance, the physical action could comprise bringing the portable device 110 in the immediate proximity (say, a few centimeters) of the display screen 101. Such a physical action intuitively suggests that some kind of interaction between the portable device 110 and the display screen 101 is desired. It is also easier to manipulate the portable device 110 itself than it is to manipulate a small button or icon on a display.

Alternatively, the physical action may comprise bringing the portable device 110 in the immediate proximity of an object representative of a device cluster comprising the display screen 101. As explained above, the devices 101-104 can be regarded as a group or cluster of devices. The object representative of the cluster could be one of the devices in the cluster, for instance the display screen 101 as it is the most visible device in the cluster. It could also be a specially-made object, or an object that is not one of the devices in the cluster. By bringing the portable device 110 in the immediate proximity of the object, preferably less than a few centimeters, it becomes clear that the user Of the portable device 110 wants to establish a virtual link with the device cluster.

Once the confirmation has been received from the user, the portable device 110 and the display screen 101 establish the virtual link. The virtual link can then be used to allow interaction between the portable device 110 and the display screen 101.

The LED on the portable device 110 and on the display screen 101 could now switch from blinking to continuous lighting to provide feedback that the virtual link has been established. An LCD display could be used to display an indicator for the other device, e.g. the portable device 110 could display “Television” and the display screen 101 could display “Portable TV”.

For instance, if a portable MP3 player detects a wireless headphone in its proximity (preferably defined as a distance of less than 5 cm), both devices might have a ‘linking LED’, which starts blinking for a while (a suggested link). The user can ‘link’ the devices by pressing a ‘linking button’. Possible feedback from the devices could be that their linking LEDs are now continuously on indicating that they are linked. If both devices are linked to each other they can be considered as one device cluster. This means that the MP3 player now can be used to select and control the music that is to be played on the wireless headphone.

If two people both have a portable device 110 they might want to exchange content, or use an application that is distributed over both portable devices 110 (such as a shared game, or a shared whiteboard). If a portable device 110 detects another portable device 110 in its proximity (preferably defined as a distance of less than 5 cm), it will present a suggested link. For instance, a ‘suggestion-to-link sound’ or a ‘suggestion-to-link’ graphic can be presented on both portable devices 110.

If both users accept this suggestion, their portable devices are dynamically ‘linked’. Clear feedback should be given on this, for instance by a sound and/or by a ‘being-linked graphic’ or a ‘link LED’. It is now possible to exchange content items, for instance, both portable screens can present a shared graphical container that can be used to support an easy exchange of content. Furthermore, they will be able to start a ‘shared activity’ such as sharing a whiteboard, shared browsing, playing a game together etc.

If a portable display device is used within a networked home, there might be different device clusters that the portable device 110 can be linked to. If the portable is taken into a room where a device cluster is present, a link suggestion can be presented to the user. For instance, a ‘suggestion-to-link sound’ or a ‘suggestion-to-link’ graphic can be presented on both the portable and the stationary screen. The user can ‘link’ by tapping on the ‘suggestion-to-link’ graphic. Clear feedback is should now given on the fact that the portable has become part of the device cluster, for instance by sound and/or by a ‘being-linked graphic’.

FIGS. 2a and 2b show another embodiment of the system 100, in which a portable display device 201 is brought into the vicinity of a stationary display device 202. In FIG. 2a, a television program 210 is being shown on the display of portable display device 201. Once the distance between portable display device 201 and stationary display device 202 drops below a predetermined number, both devices 201, 202 display an indication 211, 212 that serves as a suggestion that a virtual link can be established between the devices 201, 202.

The indications are shown here as a graphical element 211 on the portable device 201 (“linking bar”) and a graphical element 212 on the stationary device 202 (“linking stub”). The linking bar 211 on the portable device 201 represents the set of available stationary devices in the room, such as a large screen, a speaker set, microphone, camera etc.

Initially the two graphical linking elements 211, 212 have a semi-transparent appearance, indicating that it is still a suggestion. It is possible to give confirmation to establish the link by:

tapping on the linking bar (a ‘taplink’),

dragging a content or activity icon on the linking bar (a ‘drag link’), or

reducing the distance d, i.e. moving the portable device 201 close (preferably less than 15 cm) to the big screen 202 for one second (a ‘screen link’).

In response to receiving such a confirmation, the virtual link is established. Once the link is established, both on-screen elements 211, 212 switch from a semi-transparent appearance to opaque, as is shown in FIG. 2b. Subsequently one or more actions are executed depending on the manner in which the confirmation to establish the link was given.

For instance, suppose the display screen 202 recognizes an approaching portable device 201. The display screen 202 and/r the portable device 201 now present a linking suggestion by means of the semi-transparent linking element 211 accompanied by auditory feedback. The user can acknowledge this link by tapping on the linking element on the portable device 201. With this so-called TapLink the user of the portable device 201 complies with whatever is going on the stationary device 202. Generally this means that the user joins the activity using the portable device 201. The portable device 201 could for instance display a user interface suitable for controlling operation of the stationary device 202, or start an application such as a game with which the user can participate in the activity displayed on the stationary device 202. If a link is established the linking elements become opaque.

The user can also have the intention to continue a portable-screen activity on the stationary device 202. In that case a ScreenLink can be used to move an activity from the portable to the stationary device 202 and overrule whatever was presented there. Such a ScreenLink is preferably accomplished by explicitly holding the portable device 201 near a physical linking object 220 mounted on or near to the stationary device 202. The proximity (distance d) required to do this is typically smaller than 10 cm. The presentation of the television program 210 is now transferred to the stationary display device 202, as can be seen in FIG. 2b.

In multi-user situations a TapLink is quite a concealed manner of linking, and therefore cannot instantly overrule any activity on the stationary device 202. The latter can be realized with a ScreenLink, but since this is quite a physical explicit action other users in that location can interfere. They can see that a person is walking with a portable to the stationary device 202 and can easily verbally stop this person from executing a ScreenLink.

Once a portable device has been linked to another device or to a cluster, it can be ‘unlinked’ therefrom by:

bringing the portable device 201 outside the distance suitable for interaction, for instance by leaving the room in which the other device 202 is located (a ‘leave’),

tapping on the linking bar 201 (a ‘tap unlink’), or

moving the portable device 201 close to the device 202 for a second (a ‘screen unlink’).

To unlink a portable device from a device or cluster users have to execute actions that are similar to linking. It is always possible that a user simply walks away with a portable device that was linked, so there are three ways of unlinking: a TapUnlink, a ScreenUnlink and an Implicit Unlink (walking away).

A TapUnlink is accomplished by tapping on the opaque linking element 211 on the portable device 201. This results in an abrupt cut of the link, in the sense that whatever was presented on the wall-screen remains ongoing there and the users loses the possibility to control that activity via the portable. With a TapLink an activity can therefore be left for possible other users in that location.

On the other hand the user can also have the intention to take the activity on the wall-screen along on the portable to continue elsewhere, for example the garden. Similar to the ScreenLink, a ScreenUnlink can be realized by holding a linked portable near the wall-screen. With such a ScreenUnlink the wall-screen activity is moved to the portable.

The user can also simply walk out of the room, or increase the distance d in another way, with a linked portable, which results in an Implicit Unlink once the distance d becomes greater than the above-mentioned distance suitable for interacting. An Implicit Unlink behaves similarly to a ScreenUnlink in that any activity on the big-screen is moved to the portable. However, if other portable-screens remain linked the big-screen activity is copied to the unlinking portable instead of being moved. Furthermore, the activity that is moved or copied to the portable is paused, because an implicit unlink can indeed be very implicit in that the user can also carry the portable under the arm.

Again, a TapLink is the most concealed manner of unlinking and therefore has minimal effect on whatever is ongoing on the big-screen. ScreenUnlink and Implicit Unlink are the more physical explicit methods of Unlinking and allow easy interception by possible other users on the location of the big-screen device cluster.

After unlinking, a linking suggestion is preferably maintained on the portable device 201, until the distance between the portable device 201 and the device 202 exceeds the distance suitable for interaction.

FIG. 3 is a block diagram illustrating a possible construction of portable device 201. The portable device 201 comprises an interacting module 301, arranged for interacting with another device. This module 301 is operable to take one or more of the actions set out above when a Taplink, Screenlink or Draglink is performed by the user.

A sensor 302, such as an infrared sensor or radio transmitter/receiver, coupled to detector 303, detects if the distance d between the portable device 201 and another device is suitable for the interaction. If this is the case, the detector 303 activates the output module 304 to indicate that a virtual link can be established between the portable device 201 and the other device for allowing the interaction.

To this end, the output module 304 is connected to a loudspeaker 305 and a display 306 such as an LED. The output module 304 could e.g. generate an audio signal or cause the LED 306 to start blinking or perform any other action that will attract the user's attention. The display 306 could also be an LCD display or other screen, on which a graphical or textual message or image could be displayed to indicate that a virtual link can be established.

A button 307 is provided to allow the user to confirm that the virtual link is to be established. When the user presses this button 307, this action is detected by confirmation reception module 308. Of course the button 307 could be replaced by any input means that could serve to allow the user to give confirmation. For instance, the confirmation reception module 308 could be coupled to a touch-sensitive screen and detect that the user has touched a particular area of the screen. The button 307 could be replaced by a voice-sensitive sensor so that the confirmation reception module 308 can detect an appropriate voice command given by the user, and so on.

Upon detecting the pressing of the button, that is to say upon detecting that the user has given his confirmation, the confirmation reception module 308 activates linking module 309 to signal that the virtual link must be established. The linking module 309 then activates the interacting module 301, which in turn establishing the virtual link.

U.S. Pat. No. 5,910,797 (attorney docket PHN 15180) describes a portable device that can display one or more graphical representations of objects like content items. The device contains as a gravitation-controlled sensor for measuring a spatial orientation of the device. Depending on the spatial orientation as detected by the sensor, the graphical representations are moved on the display. If the spatial orientation is manipulated in such a way that the graphical representations would be moved off screen, the object is removed from the device or transferred to another device.

U.S. Pat. No. 5,774,673 (attorney docket PHN 15352) describes a system for wireless communication between a dynamic group of devices. Devices can join the dynamic group by transmitting a broadcast message. Upon joining, a communication channel is set up over which information can be transferred to simultaneously execute an application. This system does not require globally unique addresses for devices.

U.S. Pat. No. 6,028,866 (attorney docket PHN 15625) describes a system for communicating between a group of devices. In this system a central apparatus is used to increase the reliability of the communication. Each device is arranged to execute a group application, and can exchange messages with other devices to exchange information related to the group application.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of enabling interaction between a portable device operated by a user and another device, comprising detecting that a distance between the portable device and the other device is suitable for the interaction, suggesting to the user that a virtual link can be established between the portable device and the other device for allowing the interaction, and upon receiving a confirmation from the user, establishing the virtual link.

2. The method of claim 1, comprising receiving the confirmation as a user action performed on the portable device.

3. The method of claim 1, comprising receiving the confirmation as an indication of a physical action performed with the portable device.

4. The method of claim 3, in which the physical action comprises bringing the portable device in the immediate proximity of the other device.

5. The method of claim 3, in which the physical action comprises bringing the portable device in the immediate proximity of an object representative of a device cluster comprising the other device.

6. The method of claim 1, further comprising deriving an action that is desired by the user from the manner in which the confirmation is given by the user, and subsequently executing the action using the virtual link.

7. The method of claim 1, further comprising detecting a further user action indicative of desired termination, and in response to said detecting, terminating the virtual link.

8. The method of claim 7, in which the further user action comprises bringing the portable device outside the distance suitable for interaction.

9. A computer program product arranged for causing a processor to execute the method of claim 1.

10. A portable device arranged to be operated by a user, comprising interacting means for interacting with another device, detecting means for detecting that a distance between the portable device and the other device is suitable for the interaction, output means for indicating that a virtual link can be established between the portable device and the other device for allowing the interaction, confirmation reception means for receiving a confirmation from the user, linking means for, upon receiving a confirmation from the user, activating the interacting means and establishing the virtual link.

11. The portable device of claim 10, further comprising means for detecting a physical action performed with the portable device, coupled to the confirmation reception means.
